(19) United States
(12) Patent Application Publication
(10) Pub. No.: US 2010/0295657 A1
(43) Pub. Date: Nov. 25, 2010

(54) INTELLIGENT CONTROL SYSTEM AND METHOD

(75) Inventor: Chao-Jui Huang, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/485,921

(22) Filed: Jun. 17, 2009

(30) Foreign Application Priority Data
May 20, 2009 (CN) 200910302482.5

(51) Int. Cl. G05B 19/00

(52) U.S. Cl. 340/5.1

(57) ABSTRACT

An intelligent control system includes a RFID reader, a RFID tag, a control unit, and an electronic-device. When the RFID tag receives a radio signal from the RFID reader, the RFID tag outputs a radio response signal. The RFID reader outputs a first detecting signal in response to receiving the radio response signal and a second detecting signal in response to not receiving the radio response signal. The control unit controls the device power off or power on according to the first detecting signal or the second detecting signal.

### BACKGROUND

1. Technical Field

The present disclosure relates to intelligent control systems and methods, and particularly to an intelligent control system and a method for an electronic device.

2. Description of Related Art

An electronic device such as a security monitor in a monitored area is almost always powered on. However, in fact, the security monitor is unnecessary to work when a security guard is present. Therefore, power is sometime unnecessarily wasted.

### BRIEF DESCRIPTION OF THE DRAWINGS

FIG. 1 is a block diagram of an exemplary embodiment of an intelligent control system for an electronic device.

FIG. 2 is a flowchart diagram of an exemplary embodiment of an intelligent control method for an electronic device.

### DETAILED DESCRIPTION

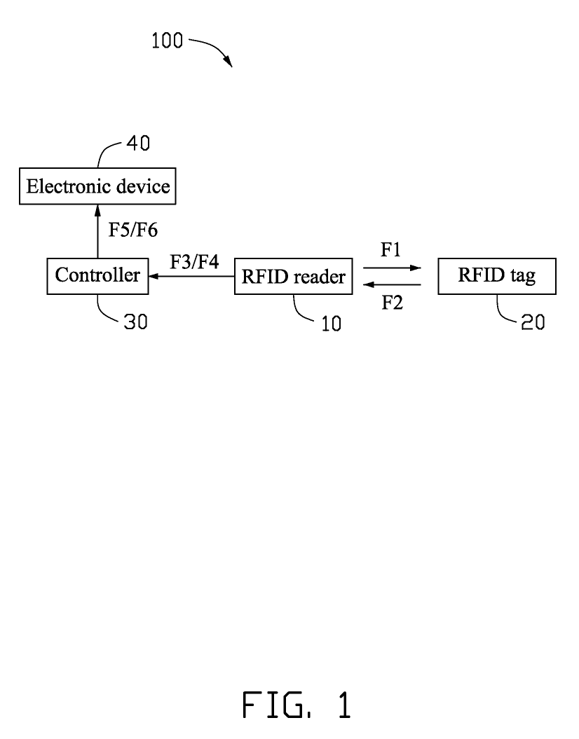

Referring to FIG. 1, an exemplary embodiment of an intelligent control system 100 includes a radio-frequency identification (RFID) reader 10, an RFID tag 20, a controller 30, and an electronic device 40. The RFID reader 10 is connected to the controller 30. The controller 30 is connected to the electronic device 40. In one exemplary embodiment, the electronic device 40 is a security monitor in a monitored area. The RFID tag 20 is carried by security guards working at the monitored area.

The RFID reader 10 continuously outputs a radio signal F1. When the RFID tag 20 is in a detectable range of the RFID reader 10, which means the security guard is present, the RFID tag 20 receives the radio signal F1 from the RFID reader 10 and output a radio response signal F2. The RFID reader 10 receives the radio response signal F2 and outputs a first sensed signal F3 to the controller 30. The controller 30 may be a computer or a control chip. The controller 30 receives the first detecting signal F3 and outputs a first control signal F5 to power off the electronic device 40.

When the RFID tag 20 is not in the detectable range of the RFID reader 10, which means the security guard is not present, the RFID tag 20 cannot receive the radio signal F1 from the RFID reader 10, and does not output the radio response signal F2. The RFID reader 10 then outputs a second detecting signal F4 to the controller 30. The controller 30 receives the second detecting signal F4 and outputs a second control signal F6 to power on the electronic device 40.

In another exemplary embodiment, the electronic device 40 may be a household appliance, such as an air condition. The RFID tag 20 may be carried by family members. When a RFID tag 20 is in the detectable range of RFID reader 10, the controller 30 controls the household appliance to work. When the RFID tag 20 is not in the detectable range of RFID reader 10, the controller 30 controls the household appliance to stop working.

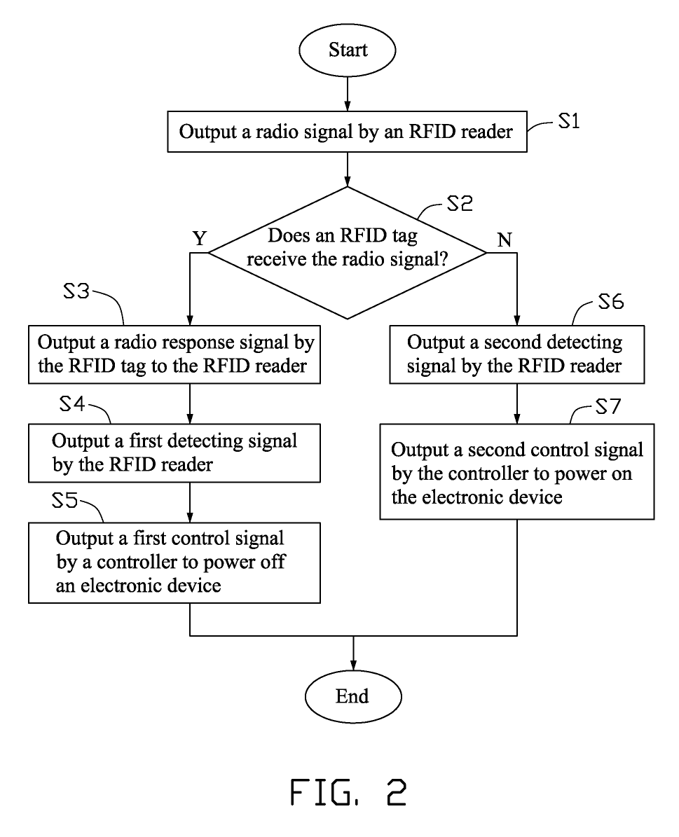

Referring to FIG. 2, an intelligent control method for the electronic device 40 includes the following steps.

In step S1, the RFID reader 10 outputs a radio signal F1.

In step S2, a determination is made on whether the RFID tag 20 receives the radio signal F1 or not. If the RFID tag 20 receives the radio signal F1, the flow goes to step S3. If the RFID tag 20 does not receive the radio signal F1, the flow goes to step S6.

In step S3, the RFID tag 20 outputs a radio response signal F2 to the RFID reader 10.

In step S4, the RFID reader 10 outputs a first detecting signal F3 to the controller 30.

In step S5, the controller 30 outputs a first control signal F5 to power off the electronic device 40.

In step S6, the RFID reader 10 outputs a second detecting signal F4 to the controller 30.

In step S7, the controller 30 outputs a second control signal F6 to power on the electronic device 40.

It is to be understood, however, that even though numerous characteristics and advantages of the present disclosure have been set forth in the foregoing description, together with details of the structure and function of the disclosure, the disclosure is illustrative only, and changes may be made in details, especially in matters of shape, size, and arrangement of parts within the principles of the disclosure to the full extent indicated by the broad general meaning of the terms in which the appended claims are expressed.

What is claimed is:

1. An intelligent control system, comprising:
a radio-frequency identification (RFID) reader to output a radio signal;
an RFID tag to output a radio response signal in response to receiving the radio signal; wherein the RFID reader is further to output a first detecting signal in response to receiving the radio response signal, or output a second detecting signal in response to not receiving the radio response signal;
a controller connected to the RFID reader, to output a first control signal or a second control signal in response to receiving the first detecting signal or the second detecting signal from the RFID reader; and
an electronic device connected to the controller, to be powered on or powered off in response to receiving the first control signal or the second control signal from the controller.

2. The intelligent control system of claim 1, wherein the controller is a computer or a control chip.

3. The intelligent control system of claim 1, wherein the electronic device is a security monitor.

4. The intelligent control system of claim 1, wherein the electronic device is a household appliance.

5. An intelligent control method for an electronic device, comprising:
outputting a radio signal via a radio-frequency identification (RFID) reader;
outputting a radio response signal by a RFID tag in response to receiving the radio signal;
outputting a first detecting signal by the RFID reader in response to receiving the radio response signal; and
outputting a first control signal by a controller to power off the electronic device in response to receiving the first detecting signal.

6. The method of claim 5, further comprising:
outputting a second detecting signal by the RFID reader in response to not receiving the radio response signal; and
outputting a second control signal by the controller to power on the electronic device in response to receiving the second detecting signal.

7. The method of claim 5, wherein the controller is a computer or a control chip.

8. The method of claim 5, wherein the electronic device is a security monitor.

9. The method of claim 5, wherein the electronic device is a household appliance.
